(19) United States
(12) Patent Application Publication
(10) Pub. No.: US 2011/0047522 A1
(43) Pub. Date: Feb. 24, 2011

(54) Hardware Description Language Editing Engine

(76) Inventors: Mark W.P. Dane, Chipping Norton (GB); Gordon N. Walker, Marlborough (GB); Rakesh K. Gupta, Noida (IN)

Correspondence Address: MENTOR GRAPHICS CORP.;PATENT GROUP, 8005 SW BOECKMAN ROAD, WILSONVILLE, OR, 97070-7777, US

(21) Appl. No.: 12/785,419

(22) Filed: May 21, 2010

Related U.S. Application Data
(60) Provisional application No. 61/180,358, filed on May 21, 2009.

(51) Int. Cl. G06F 17/50

(52) U.S. Cl. 716/112

(57) ABSTRACT

Technologies for editing a circuit design implemented in a hardware description language are provided. A representation of a circuit design described by a syntactic description of the circuit is generated. Subsequently, a modification operation is carried out on the circuit design representation after which a modified syntactic description may be generated from the modified representation.

### RELATED APPLICATIONS

This application claims priority under 35 U.S.C. §119(e) to U.S. Provisional Patent Application No. 61/180,358 entitled “Editing Engine for Hardware Description Language Data,” filed on May 21, 2009, and naming Mark Dane et al. as inventors, which application is incorporated entirely herein by reference.

### FIELD OF THE INVENTION

The invention relates to the field of circuit design utilizing hardware description languages. More particularly, various implementations of the invention are applicable to modifying circuit designs implemented in a hardware description language.

### BACKGROUND OF THE INVENTION

Today, the design of electronic devices no longer begins with diagramming an electronic circuit. Instead, the design of modern electronic devices, and particularly integrated circuits (“IC's”), often begins at a very high level of abstraction. For example, a design may typically start with a designer creating a specification that describes particular desired functionality. This specification, which may be implemented in C, C++, SystemC, or some other programming language, describes the desired behavior of the device at a high level. Device designs at this level of abstraction are often referred to as “algorithmic designs,” “algorithmic descriptions,” or “electronic system level (“ESL”) designs”. Designers then take this algorithmic design, which may be executable, and create a logical design through a synthesis process. The logical design will often be embodied in a netlist. Frequently, the netlist is a register transfer level (“RTL″) netlist.”

Designs at the register level are often implemented by a hardware description language (“HDL”) such as SystemC, Verilog, SystemVerilog, or Very High speed hardware description language (“VHDL”). A design implemented in HDL describes the operations of the design by defining the flow of signals or the transfer of data between various hardware components within the design. For example, an RTL design describes the interconnection and exchange of signals between hardware registers and the logical operations that are performed on those signals.

Designers subsequently perform a second transformation. This time, the register transfer level design is transformed into a gate level design. Gate level designs, like RTL designs, are also often embodied in a netlist, such as, a mapped netlist for example. Gate level designs describe the gates, such as AND gates, OR gates, and XOR gates that comprise the design, as well as their interconnections. In some cases, a gate level netlist is synthesized directly from an algorithmic description of the design, in effect bypassing the RTL netlist stage described above.

Once a gate level netlist is generated, the design is again taken and further transformations are performed on it. First the gate level design is synthesized into a transistor level design, which describes the actual physical components such as transistors, capacitors, and resistors as well as the interconnections between these physical components. Second, place and route tools then arrange the components described by the transistor level netlist and route connections between the arranged components. Lastly, layout tools are used to generate a mask that can be used to fabricate the electronic device, through for example an optical lithographic process.

During the design process, designers often desire to make changes to the design. Typically, these changes take place at the RTL level. For example, it is common for designers to add components or to add signals to a design. Additionally, it may be desirable that a component be moved between levels in a hierarchical design. However, as those of skill in the art can appreciate, it is a time consuming and tedious process to make these and other changes to a circuit design. Furthermore, errors can easily be introduced into the design as these changes are made.

### SUMMARY OF THE INVENTION

Various implementations of the invention provide methods and apparatuses to modify a syntactic description of a circuit. Various implementations may be employed to perform high-level modifications of the syntactic description, such as, for example, changing the name of a signal, adding signals, or adding ports, among other modifications. Furthermore, various implementations may be utilized to propagate changes through text files comprising the syntactic description, instantiate the syntactic description in a software program, and enable adherence to various design styles, or coding styles.

In some implementations, a modification request for a syntactic description is received. Following which a lexicon corresponding to the syntactic description is identified. Subsequently, a representation of the circuit design described by the syntactic description is generated. The modification operation is carried out on the circuit design representation and a modified syntactic description is generated from the modified representation.

### BRIEF DESCRIPTION OF THE DRAWINGS

The present invention will be described by way of illustrative embodiments shown in the accompanying drawings in which like references denote similar elements, and in which:

FIG. 1 shows an illustrative computing environment;

FIG. 2 shows a method of editing a syntactic description of a circuit design;

FIG. 3 shows a portion of a syntactic description of a circuit;

FIG. 4 shows the method of editing a syntactic description of a circuit design shown in FIG. 2 in alternate detail; and

FIG. 5 shows a method of generating a modified syntactic description.

### DETAILED DESCRIPTION OF ILLUSTRATIVE IMPLEMENTATIONS

The operations of the disclosed implementations may be described herein in a particular sequential order. However, it should be understood that this manner of description encompasses rearrangements, unless a particular ordering is required by specific language set forth below. For example, operations described sequentially may in some cases be rearranged or performed concurrently. Moreover, for the sake of simplicity, the illustrated flow charts and block diagrams typically do not show the various ways in which particular methods can be used in conjunction with other methods.

It should also be noted that the detailed description sometimes uses terms like “determine” to describe the disclosed methods. Such terms are often high-level abstractions of the actual operations that are performed. The actual operations that correspond to these terms will often vary depending on the particular implementation, and will be readily discernible by one of ordinary skill in the art.

Furthermore, in various implementations of the invention, a mathematical model may be employed to represent an electronic device. With some implementations, a model describing the connectivity of the device, such as for example a netlist, is employed. Those of skill in the art will appreciate that the models, even mathematical models represent real world device designs and real world physical devices. Accordingly, manipulation of the model, even manipulation of the model when stored on a computer readable medium, results in a different device design. More particularly, manipulation of the model results in a transformation of the corresponding physical design and any physical device rendered or manufactured by the device design. Additionally, those of skill in the art can appreciate that during many electronic design and verification processes, the response of a devices design to various signals or inputs is simulated. This simulated response corresponds to the actual physical response the device being modeled would have to these various signals or inputs.

Some of the methods described herein can be implemented by software stored on a computer readable storage medium, or executed on a computer. Accordingly, some of the disclosed methods may be implemented as part of a computer implemented electronic design automation (EDA) tool. The selected methods could be executed on a single computer or a computer networked with another computer or computers. For clarity, only those aspects of the software germane to these disclosed methods are described; product details well known in the art are omitted.

### Illustrative Computing Environment

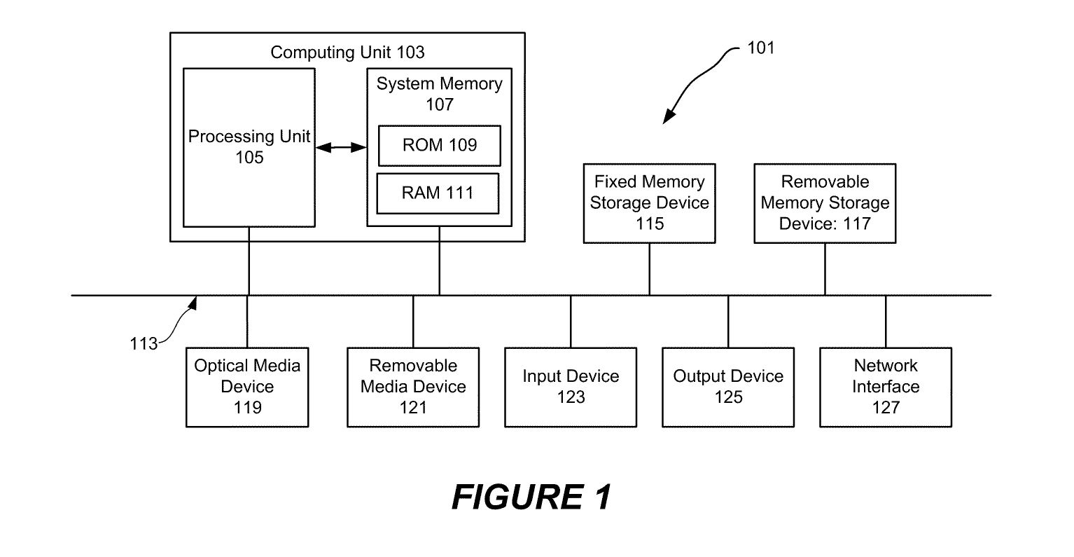

As the techniques of the present invention may be implemented using software instructions, the components and operation of a generic programmable computer system on which various implementations of the invention may be employed is described. Accordingly, FIG. 1 shows an illustrative computing device 101. As seen in this figure, the computing device 101 includes a computing unit 103 having a processing unit 105 and a system memory 107. The processing unit 105 may be any type of programmable electronic device for executing software instructions, but will conventionally be a microprocessor. The system memory 107 may include both a read-only memory (ROM) 109 and a random access memory (RAM) 111. As will be appreciated by those of ordinary skill in the art, both the read-only memory (ROM) 109 and the random access memory (RAM) 111 may store software instructions for execution by the processing unit 105.

The processing unit 105 and the system memory 107 are connected, either directly or indirectly, through a bus 113 or alternate communication structure, to one or more peripheral devices. For example, the processing unit 105 or the system memory 107 may be directly or indirectly connected to one or more additional devices, such as; a fixed memory storage device 115, for example, a magnetic disk drive; a removable memory storage device 117, for example, a removable solid state disk drive; an optical media device 119, for example, a digital video disk drive; or a removable media device 121, for example, a removable floppy drive. The processing unit 105 and the system memory 107 also may be directly or indirectly connected to one or more input devices 123 and one or more output devices 125. The input devices 123 may include, for example, a keyboard, a pointing device (such as a mouse, touchpad, stylus, trackball, or joystick), a scanner, a camera, and a microphone. The output devices 125 may include, for example, a monitor display, a printer and speakers. With various examples of the computing device 101, one or more of the peripheral devices 115-125 may be internally housed with the computing unit 103. Alternately, one or more of the peripheral devices 115-125 may be external to the housing for the computing unit 103 and connected to the bus 113 through, for example, a Universal Serial Bus (USB) connection.

With some implementations, the computing unit 103 may be directly or indirectly connected to one or more network interfaces 127 for communicating with other devices making up a network. The network interface 127 translates data and control signals from the computing unit 103 into network messages according to one or more communication protocols, such as the transmission control protocol (TCP) and the Internet protocol (IP). Also, the interface 127 may employ any suitable connection agent (or combination of agents) for connecting to a network, including, for example, a wireless transceiver, a modem, or an Ethernet connection.

It should be appreciated that the computing device 101 is shown here for illustrative purposes only, and it is not intended to be limiting. Various embodiments of the invention may be implemented using one or more computers that include the components of the computing device 101 illustrated in FIG. 1, which include only a subset of the components illustrated in FIG. 1, or which include an alternate combination of components, including components that are not shown in FIG. 1. For example, various embodiments of the invention may be implemented using a multi-processor computer, a plurality of single and/or multiprocessor computers arranged into a network, or some combination of both.

### Hardware Description Language Editing

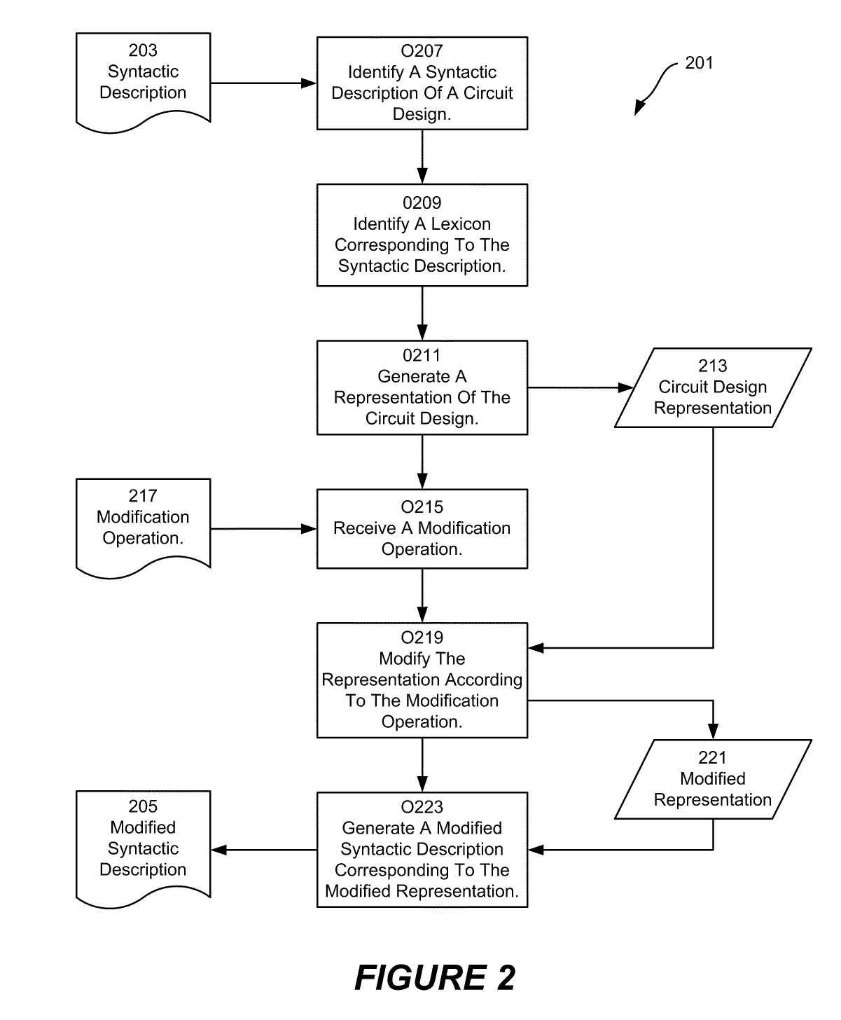

As stated above, designers often desire to make changes to a design at multiple points during the design phase. For example, often times it is desirable to make changes to a register transfer level description of a circuit embodied in a hardware description language, such as, for example, SystemVerilog. FIG. 2 illustrates a method 201 that may be provided by various implementations of the present invention to edit a syntactic description of a circuit design 203, resulting in the generation of a modified syntactic description 205. In various implementations, “a syntactic description” refers to a description of a circuit design, often expressed in text, which conforms to one or more hardware description languages. With some implementations, the hardware description language is SystemVerilog. With alternative implementations, the hardware description language is VHDL. Still, in alternative implementations, the hardware description language is Verilog. Still further, in some implementations, the hardware description language is a programming language capable of behaviorally and structurally describing a circuit.

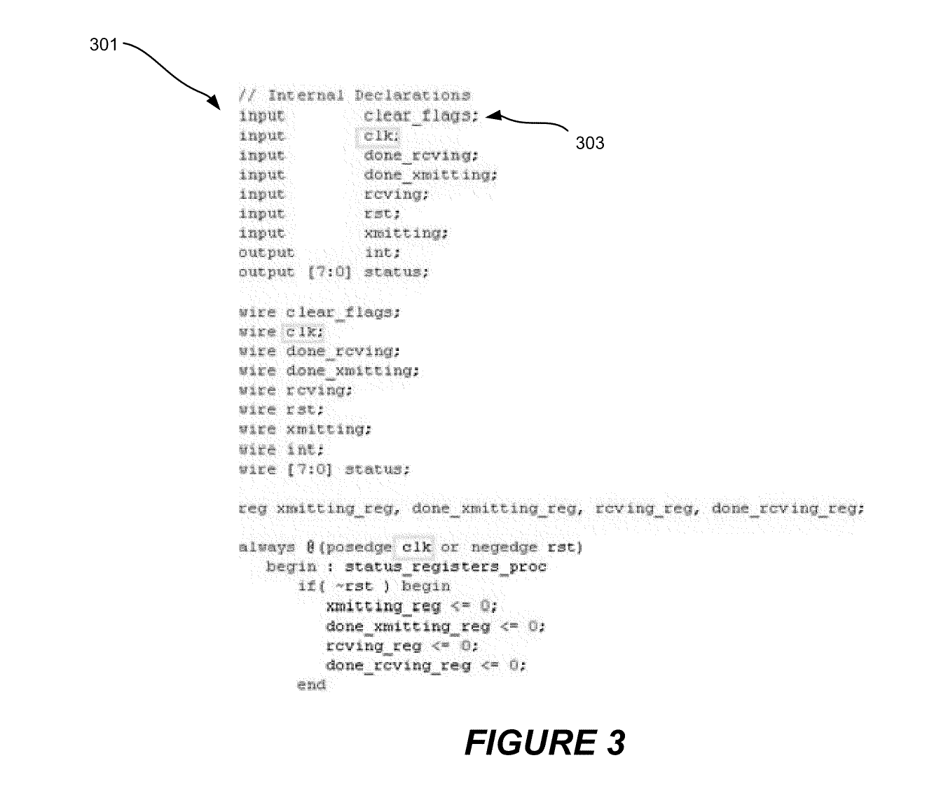

For example, FIG. 3 illustrates a portion 301 of a syntactic description of a circuit design, expressed in SystemVerilog. As can be seen from this figure, the portion 301 of the syntactic description includes syntax statements that define or specify the behavioral and structural properties of the circuit design. As illustrated in this figure, each line of the portion 301 represents a syntax statement, for example, the syntax statement 303.

Returning to FIG. 2, the method 201 includes an operation 207 for identifying a syntactic description of a circuit design. As shown, the operation 207 identifies the syntactic description 203. The method 201 further includes an operation 209 for identifying a lexicon corresponding to the syntactic description. As stated above, the syntactic description corresponds to a hardware description language, such as, for example, SystemVerilog. Accordingly, the lexicon corresponding to the syntactic description in this case would be a specification for SystemVerilog. As an alternative example, if the syntactic description were implemented in VHDL 200X, then the lexicon would be a specification for VHDL 200X. As those of skill in the art can appreciate, the specification acts as a reference and details the permissible words, or commands, and their potential combination that enables a circuit design to be behaviorally and structurally described.

The method 201 further includes: an operation 211 for generating a circuit design representation 213 from the syntactic description 203 and the lexicon; an operation 215 for receiving a modification operation 217; an operation 219 for modifying the circuit design representation 213 according to the modification operation 217, resulting in a modified representation 221; and an operation 223 for generating the modified syntactic description from the modified representation 221.

### Circuit Design Representation Generation

In various implementations of the invention, the circuit design representation 213 is a syntax tree corresponding to the circuit design. In further implementations, the circuit design representation 213 also includes a corresponding model of the circuit, such as, for example, a SPICE model. With various implementations, the circuit design representation 213 is stored onto a memory storage location. It may be advantageous, in some cases to have the circuit design representation 213 be persistent (i.e. continuously stored onto a memory storage location) for performance reasons or for enabling future reference to the circuit design representation 213.

With some implementations, the circuit design representation 213 includes either or all of the following: the actual syntax of the syntactic description 203, including any code comments; character positions; “tokens” corresponding to the various components within the circuit design (“tokens” will be further explained below); the design constraints, such as, for example, “define definitions” in the case of a Verilog lexicon; the hierarchy of the circuit design, which may be a static hierarchy extracted from the syntactic description 203, a fully elaborated hierarchy, or both; and the connectivity of the design (i.e. which components are connected to which other components and the nature of the these connections).

### Modification Operations

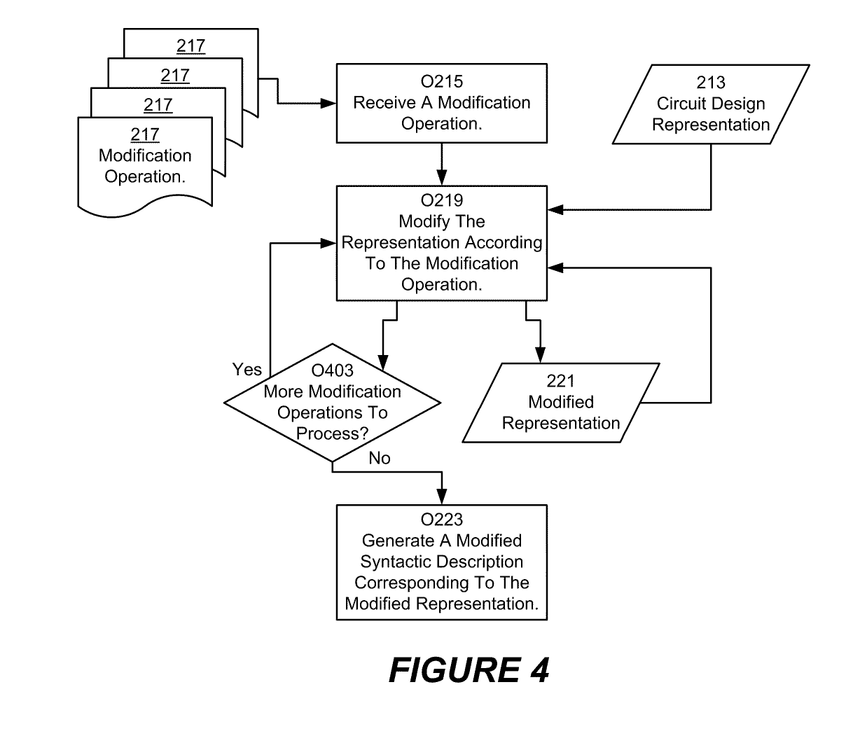

The modification operation 217 may be one or a number of operations to “modify” the circuit design, which will require a corresponding modification to the syntactic description 203 for the circuit design to be accurately represented. In various implementations, the operation 215 receives a plurality of modification operations 217. For example, FIG. 4 shows a portion of the method 201 that may be operated in a loop, to process multiple modification operations 217. As can be seen from this figure, multiple modification operations 217 are shown being received by the operation 215. Accordingly, multiple modifications need to be made the circuit design representation 213.

FIG. 4 includes an operation 403 for determining if more modification operations 217 need to be processed. If more modification operations 217 do need to be processed, then the operations 219 for modifying the representation according to the modification operation is executed on a modification operation 217 that has not been applied to the circuit design representations yet. However, as illustrated, the operation 219 may make changes to either the circuit design representation 213 or the modified representation 221. In various implementations, the first time that the operation 219 is executed; it operates to modify the circuit design representation, which in turn generates the modified representation 221. During subsequent executions of the operation 219, the modified representation 221 is further modified according to additional modification operations 217. As can be seen, when no further modification operations needs to be processed, then the method proceeds to the operation 223, as in FIG. 2.

In various implementations, a multitude of different types of modification operations, such as, for example, adding or removing a component, may be performed. A few illustrative potential modification operations will be briefly discussed below.

### Generation of a Modified Syntactic Description

Returning to FIG. 2, as stated, the method 201 provides for the generation of the modified syntactic description 205. In various implementations, the operation 223 “writes out” the modified syntactic description to text files having the same syntactical format and complying with the lexicon as the original syntactic description 203, including code comments, indentation styles, and port styles. In many cases, this process generates a plurality of text files corresponding to the hardware description language files required for describing a circuit design. In various implementations, the modified syntactic description 205 is stored on a memory storage location. In some implementations, the modified syntactic description 205 is output to a printing device. Still, in some implementations, the modified syntactic description 205 is output to a display device.

In various implementations, the operation 223 generates the modified syntactic description 205 be employing “tokens.” As used herein, a token is a bookmark, which references locations within the syntactic description 203 where a particular object, such as, for example, a port, within the circuit design representation (i.e. the representation 213 and 221) is referenced.

As those of skill in the art can appreciate, there are often multiple references to a particular object within the syntactic description 203. As a result, each object may have multiple tokens associated with it. In various implementations, these tokens are represented as file offsets. For example, assuming the syntactic description 203 has three files, and the third file has 10 lines. An illustrative token may be the third file, fifth line. In alternative implementations, a token may include a start location and an end location, such as, for example, by marking starting and ending locations by reference to their locations within the file in hexadecimal.

In various implementations, tokens are associated with each component of the syntactic description, including code comments, and character offsets, such as, for example tab or line return characters when the circuit design representation 213 in generated by the operation 211.

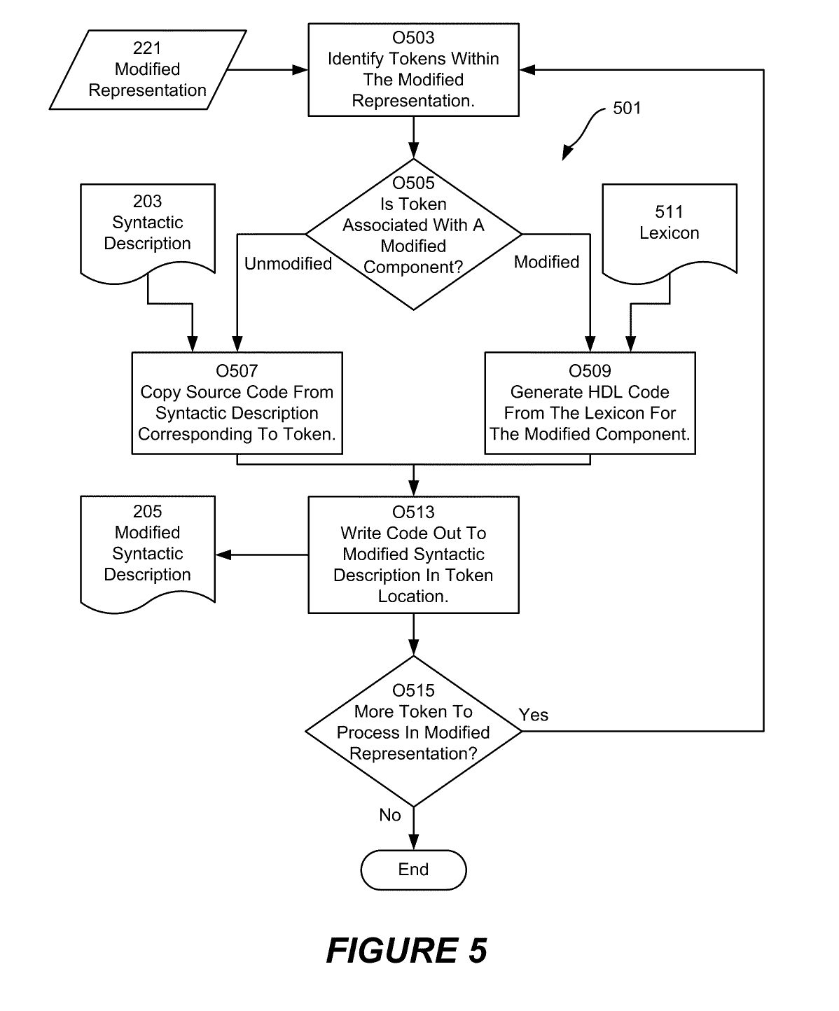

FIG. 5 illustrates a method of generating a modified syntactic description 205 from a modified representation 221 having tokens associated with it and an original syntactic description 203. As can be seen from this figure, the method 501 includes an operation 503 for identifying a token within the modified representation 221 and an operation 505 for determining if the identified token is associated with an unmodified components or a modified component. As used herein, a modified component is any component changed, added, or otherwise modified between the circuit design representation 213 and the modified representations 221. Subsequently, as can be seen, if the token is associated with an unmodified component, an operation 507 for copying the source code from the syntactic description 203 corresponding to the token is provided. Alternatively, if the token is associated with a modified component, an operation 509 for generating compliant hardware description language code based upon the previously identified lexicon 511 that behaviorally and structurally describes the modified component.

The method 501 further includes an operation 513 for writing out the code to the modified syntactic description 205 in the token location. In the case of an unmodified components, the token location will either not change at all, or may be slightly shifted due to adjacent modified components. However, in the case of a modified component, the token location may need to be determined based upon token locations for components adjacent to the particular modified component. Subsequently, the method 501 includes an operation 515 for determining if more tokens need to be processed in the modified representation 221. As can be seen, if more token are to be processed, the method 501 is repeated. However, if all token within the modified representation 221 have been processed, the method 501 ends, and the modified syntactic description 205 is complete.

### Illustrative Modification Operations

Changing Components: In various implementations, the modification operation 217 specifies that a particular component of the circuit design be changed, such as, for example, changing the name of a port. Alternatively, the change may be that a particular type of components be modified somehow, such as, for example, changing the resistance of a resistor, or changing a particular model of integrated circuit within the circuit design to another model. As detailed above, the component to be changed will be represented in one location within the circuit design representation, but will likely, be reference in multiple locations within the syntactic description. Accordingly, when the modified syntactic description 205 is generated, the tokens corresponding to the changed component must be utilized such that the change is propagated correctly throughout the modified syntactic description 205.

Adding Components: With some implementations, the modification operation 217 specifies that a component should be added to the circuit design. In this case, the operation 219 will add a new component (e.g. corresponding to the component specified in the modification operation 217) to the circuit design representation 213. This newly added component will be added into the syntax tree of the circuit design representation 213. The addition of components may affect the token locations of the rest of the components in the syntax tree. The token locations, including any character offsets would need to be manipulated, such as, for example, propagating token adjustments down the syntax tree, to maintain consistency of style in the modified syntactic description 205.

Removing Components: With some implementations, the modification operation 217 specifies that a component should be removed from the circuit design. In this case, the operation 219 will remove references to this component form the syntax tree. In various implementations, this includes either changing the dependency to another item, including the possibility of adding a new item, or removing that dependency as well.

Moving Components: With some implementations, the modification operation 217 specifies that a component should be moved within the circuit design, such as, for example, changing the connectivity of a component or changing the location of a planned and routed component. In various implementations, a component may be moved by first removing the component and subsequently adding the component to the new location.

### CONCLUSION

Although certain devices and methods have been described above in terms of the illustrative embodiments, the person of ordinary skill in the art will recognize that other embodiments, examples, substitutions, modification and alterations are possible. It is intended that the following claims cover such other embodiments, examples, substitutions, modifications and alterations within the spirit and scope of the claims.

1. A computer-implemented method for editing circuit design data, the method comprising:
identifying a syntactic description of a circuit design, the syntactic description defining structural and behavioral properties of the circuit design according to a lexicon;
receiving a modification operation, the modification operation describing a change to be made to the circuit design; and
editing the syntactic description to implement the modification operation such that the structural and behavioral properties remain equivalent according to the lexicon; and
saving the edited syntactic description to a non-transitory memory storage location.

2. (canceled)

3. A computer-implemented method for editing circuit design data, the method comprising:
identifying a syntactic description of a circuit design, the syntactic description defining structural and behavioral properties of the circuit design according to a lexicon;
receiving a modification operation, the modification operations describing a change to be made to the circuit design;
generating a modified syntactic description by changing the syntactic description to implement the modification operation, wherein the modified syntactic description complies with the lexicon; and
saving the modified syntactic description to a non-transient memory storage location.

4. The computer-implemented method recited in claim 3, the modification operation specifying a port, having a set of port properties, to add to the circuit design, and the method act of generating a modified syntactic description by changing the syntactic description to implement the modification operation comprising:
identifying one or more locations within the circuit design to which the port is to be added;
identifying statements from the lexicon that structurally and behaviorally describe the set of port properties;
for each of the one or more locations, forming a syntax statement from the identified statements that corresponds to the location; and
adding the one or more syntax statements to the syntactic description.

5. The computer-implemented method recited in claim 4, the set of port properties including:
a port name;
a port type; and
a port direction.

6. The computer-implemented method recited in claim 5, wherein the lexicon is a hardware description language specification.

7. The computer-implemented method recited in claim 3, the modification operation specifying a signal within the circuit design to be renamed, and the method act of generating a modified syntactic description by changing the syntactic description to implement the modification operation comprising:
receiving a new name for the signal;
identifying one or more sentences within the syntactic description that define the signal;
removing the one or more identified sentences that define the signal from the syntactic description;
identifying statements from the lexicon that structurally and behaviorally describe the signal;
for each of the one or more identified sentences that define the signal, forming a syntax statement from the identified statements that corresponds to the new name; and
adding the one or more syntax statements to the syntactic description.

8. The computer-implemented method recited in claim 3, the modification operation specifying a process within the circuit design to be modified, and the method act of generating a modified syntactic description by changing the syntactic description to implement the modification operation comprising:
identifying one or more signals within the circuit design that utilize the process;
identifying one or more sentences within the syntactic description that correspond to the signals;
identifying statements from the lexicon that structurally and behaviorally describe the signals and the process;
for each of the one or more identified sentences that correspond to the signals, forming a syntax statement from the identified statements that corresponds to the signal and the process;
removing the one or more identified sentences that correspond to the signals from the syntactic description; and
adding the one or more syntax statements to the syntactic description.

9. The computer-implemented method recited in claim 3, the modification operation specifying a process within the circuit design to be modified, and the method act of generating a modified syntactic description by changing the syntactic description to implement the modification operation comprising:
identifying one or more signals within the circuit design that utilize the process;
identifying one or more sentences within the syntactic description that correspond to the signals;
identifying statements from the lexicon that structurally and behaviorally describe the signals and the process;
for each of the one or more identified sentences that correspond to the signals, forming a syntax statement from the identified statements that corresponds to the signal and the process;
removing the one or more identified sentences that correspond to the signals from the syntactic description; and
adding the one or more syntax statements to the syntactic description.
